(19) United States
(12) Patent Application Publication
(10) Pub. No.: US 2010/0241451 A1
(43) Pub. Date: Sep. 23, 2010

(54) Electronic Chain Of Custody Systems And Methods For Use With Drug Testing

(75) Inventors: Steve Gatt, Scottsdale, AZ (US); Jangbir Sangha, Overland Park, KS (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Choicepoint Asset Company, Alpharetta, GA (US)

(21) Appl. No.: 12/305,865

(22) PCT Filed: Jun. 20, 2007
(86) PCT No.: PCT/US07/71684

§ 371 Date: Dec. 19, 2008

Related U.S. Application Data
(60) Provisional application No. 60/815,077, filed on Jun. 20, 2006.

(51) Int. Cl. G06Q 50/00; G06Q 10/00; G06F 15/16

(52) U.S. Cl. 705/3; 709/219

(57) ABSTRACT

Electronic chain of custody systems and methods for use with drug testing protocols are provided. According to some embodiments of the present invention, an electronic chain of custody (“COC”) system provides a digitally stored chain of custody record. The digitally stored chain of custody record can be updated in various fashions including direct computer input of use chain of custody form. For example, the chain of custody form can be used in concert with a data gathering digital pen that can store and pass along pen movements (as data) related to the chain of custody form. Advantageously, the present invention's digital chain of custody system and process enables integration of data from multiple system participants to a digital chain of custody record that obviates the necessity of passing along a conventional paper record. In addition, components of the present invention allow printing the digital COC record and using data recording devices to record data (e.g., handwriting data) to add to the printed COC record, which can be substantially simultaneously added to the digital COC record. Other embodiments are also claimed and described.

### CROSS REFERENCE TO RELATED APPLICATION & PRIORITY CLAIM

The present application claims priority to and the benefit of U.S. Provisional Application No. 60/815,077 filed on 20 Jun. 2006, which is hereby incorporated by reference as if fully set forth below.

### TECHNICAL FIELD

The various embodiments of the present invention relate generally to systems for maintaining chain of custody information, and more particularly, electronic chain of custody systems and methods that utilize electronic chain-of-custody forms enabling integration of chain of custody data from multiple sources.

### BACKGROUND

Many laws exist in the United States and other countries throughout the world that are directed to controlling and limiting how citizens use drugs. While many use drugs legally through prescriptions given by medical professionals, there are plenty of people who use drugs illegally. Illegal drug users run the gamut between recreational users and addicts. Given the existence of laws against drugs, potential harmful effect of drugs, potential harm that drug users can cause to others, and negative public perception of drug users, many businesses and employers have implemented policies requiring employees and workers to be drug free. Similarly, many law enforcement agencies have implemented drug testing polices for testing people to determine if illegal activity has occurred.

A drug test is typically a process using some kind of biological matter taken from an individual to determine if previous drug use has occurred. Due to privacy and evidentiary issues that exist with drug test results that include the possibility of tampering with drug test results, many employers and law enforcement agencies utilize third-party testing facilities. Such facilities can include hospitals, physician offices, or other establishments specializing in drug tests. To ensure that drug test samples and test results remain free from tampering, chain of custody procedures are usually implemented to maintain historical information related to drug test samples and test results.

Chain of custody is a term referring to the process of ensuring and providing documentation of proper specimen identification and handling from the time of collection to the receipt of laboratory results. If test results come under challenge, test specimens must have been handled according to chain of custody procedures to withstand challenge. Typical chain of custody protocols assure that a specimen belongs to the individual whose information is associated with the specimen, no adulteration or tampering has taken place, exactly who possessed the specimen and when, how the specimen was transported and stored before it was analyzed, no unauthorized access to the specimen was possible, and that the specimen was handled in a secure manner. As one might imagine, handling and keeping track of the above pieces of information in chain of custody systems can be arduous and burdensome, especially given the large number of drug tests that are completed every year.

Conventional chain of custody in place today, while serving their respective purposes, do posses certain drawbacks. These drawbacks include high costs associated with maintaining proper and legal chain of custody systems, inability to give instant status updates on a test specimen, continued dependence on paper record keeping systems with stock forms, and real-time communication regarding various data associated with drug testing. Other drawbacks associated with conventional chain of custody systems include lack of complete electronic systems that provide user-friendly interaction and continued data collection requirement regarding, for example, tested individuals, test specimens, and test results.

What is needed, therefore, are chain of custody systems and methods that address and overcome the above discussed and other drawbacks. The various embodiments of the present invention provide electronic chain of custody systems and methods that utilize electronic chain-of-custody forms to enable efficient chain of custody procedures and integration of chain of custody data from multiple sources to a centralized, digitally-stored digital chain of custody record. The various embodiments of the present invention also enable businesses and employees to comply with drug laws and implement drug policies in an economic yet effective fashion. Thus, it is to the provision of such electronic chain of custody methods and systems that the various embodiments are directed.

### BRIEF SUMMARY

The various embodiments of the present invention provide electronic chain of custody methods and systems. In accordance with currently preferred embodiments, an electronic chain of custody system can be used to process, monitor, and manage drug testing programs and associated data. An electronic chain of custody system can contain multiple user sites and a central data storage and controller site. The central data storage can maintain a digital electronic chain of custody record. At drug testing sites, the system can include computing and data collection equipment to receive data from test sample donors and test sample collectors. This received data can be provided to the central data storage to update an electronic chain of custody record. At client sites, users can access the central data storage to obtain information about a chain of custody record. Thus, data can be exchanged between user sites and the central data storage. Advantageously, a digital chain of custody as discussed herein enables many users to record and transmit chain of custody information to a central storage facility so that other users can access this information to obtain real-time chain of custody information.

Broadly described, an electronic chain of custody system of the present invention can comprise at least one digital chain of custody record stored in digital storage and at least one paper chain of custody record corresponding to the at least one digital chain of custody record. The electronic chain of custody record can contain donor information and be stored in digital storage. The paper version of the electronic chain of custody record can be configured to enable recordation of donor information. The paper version can be a replica of at least a portion of the electronic chain of custody record. In addition, the electronic chain of custody record and the paper version of the electronic chain of custody record can share a corresponding unique identifier. Also, the paper version of the electronic chain of custody record can comprise a removable portion. The removable portion can have a unique identifier corresponding to the electronic chain of custody record and it can be configured to be securedly affixed to a container holding a test specimen.

The system can also include a data recording device for use with the paper version of the electronic chain of custody record. The data recording device can record data added to the paper version and provide the added data to the digital storage such that the electronic chain of custody record is updated with the data added to the paper version. The data recording device can be a mobile computing unit having an electronic version of the electronic chain of custody record stored on the mobile computing unit. The data recording device can also have a unique identifier associated with it such that the data recording device can be distinguished from another data recording device.

An electronic chain of custody system can also include other features. For example, the data recording device can be a digital pen. The digital pen can comprise a memory, a processor, and a wireless transceiver, and the digital pen can communicate with the digital storage. As another example, the paper version of the electronic chain of custody record can comprise a pattern for use with a digital pen. The digital pen can be configured to record written data with reference to at least a portion of the pattern. As another example, a system can include multiple data collection points to receive additional donor information. The multiple data collection points can be linked to the digital storage to update electronic chain of custody information corresponding to the additional recorded donor information. Also, the electronic chain of custody record may have multiple paper versions that correspond to the electronic chain of custody record.

Generally described, other embodiments of the present invention can include a method to implement an electronic chain of custody to obtain chain of custody information for a drug test specimen provided by a donor. Such a method can comprise providing data storage to store a plurality of unique electronic chain of custody records. The records can containing custody information associated with a test specimen. A method can also include providing one or more paper versions of at least one of the electronic chain of custody records. The one or more paper versions can contain data from at least one electronic chain of custody record and the paper versions can be configured to receive chain of custody record data. A method can also include providing a data recording device to receive chain of custody record data provided on paper versions of an electronic chain of custody record.

Method embodiments according to the present invention can also include additional features. For example, a method can include receiving data associated with testing a drug test specimen and providing the received data to the data storage. Also, a method can include providing electronic chain of custody record data. In addition, a method can include storing test result data obtained from testing a test specimen. A method can also include providing at least one of a digital pen or mobile computing unit as a data recording device for use with a version of an electronic chain of custody record. As another example, a method can also include providing a machine-readable pattern on the one or more paper versions of at least one of the electronic chain of custody records and configuring the data recording device to obtain location information associated with the machine-readable pattern. Other method features can include printing paper versions of an electronic chain of custody records to have a unique identifier to link an electronic chain of custody record to an associated paper version, providing a data recording device with a unique identifier, and aggregating drug testing data from a plurality of remote locations to update the electronic chain of custody of record. Still yet, a method can also include assigning a unique identifier to a drug testing lab and providing the unique identifier to update an electronic chain of custody record.

According to yet another embodiment of the present invention, an electronic chain of custody system can comprise a memory, a plurality of data collection points, and at least one data recording device. The memory can store a plurality of unique electronic chain of custody records. The plurality of data collection points can receive information related to the unique electronic chain of custody records. And a data recording device can be located at a data collection points. The data recording device can be configured to receive chain of custody data so that a unique electronic chain of custody record is updated with received chain of custody data. Also, the memory can comprise a data server to retain the unique chain of custody records. The data server can be positioned remote from the data collection points and the at least one data recording device The plurality of data collection points can also comprise computing units to receive data from a user, and the computing units can be located remote from the memory. The data recording device can be a digital pen or mobile computing unit that can store chain of custody data for provision to the memory.

An electronic chain of custody system can also include various other features. For example, a system can include a paper version of a chain of custody records. The paper version can containing data stored in a chain of custody records and be configured to receive data for updating the chain of custody record. Also, a system can include a stand alone electronic version of a chain of custody record stored on a mobile computing device. The electronic version can contain data stored in a chain of custody record and be configured to receive data for updating a chain of custody record. As another example, a data recording device can receive and store data corresponding to a pattern provided on tangible medium. As yet another example, a system can include a server module coupled to the memory. The server module can provide data associated with a chain of custody records to a user upon request. As still yet another feature example, a system can include a plurality of paper forms having a machine-readable pattern and a unique identifier. A data recording device can be configured to record chain of custody information provided on a paper form based on movement of the data recording device relative to the machine-readable pattern and provide chain of custody information and a unique identifier to the memory.

Other aspects and features of embodiments of the present invention will become apparent to those of ordinary skill in the art, upon reviewing the following description of specific, exemplary embodiments of the present invention in conjunction with the accompanying figures.

### BRIEF DESCRIPTION OF FIGURES

FIG. 1 illustrates a logical flow diagram of a conventional process flow for a chain of custody system utilizing standard paper-based forms.

FIGS. 2A & 2B (collectively FIG. 2) illustrate a system and associated information flow for an electronic chain of custody system utilizing a digital chain of custody record in accordance with some embodiments of the present invention.

FIG. 3 illustrates a logical flow diagram depicting a method embodiment of an electronic chain of custody system in accordance with some embodiments of the present invention.

### DETAILED DESCRIPTION OF PREFERRED & ALTERNATIVE EMBODIMENTS

Referring now to the figures, wherein like reference numerals represent like parts throughout the several views, exemplary embodiments of the present invention will be described in detail. Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented.

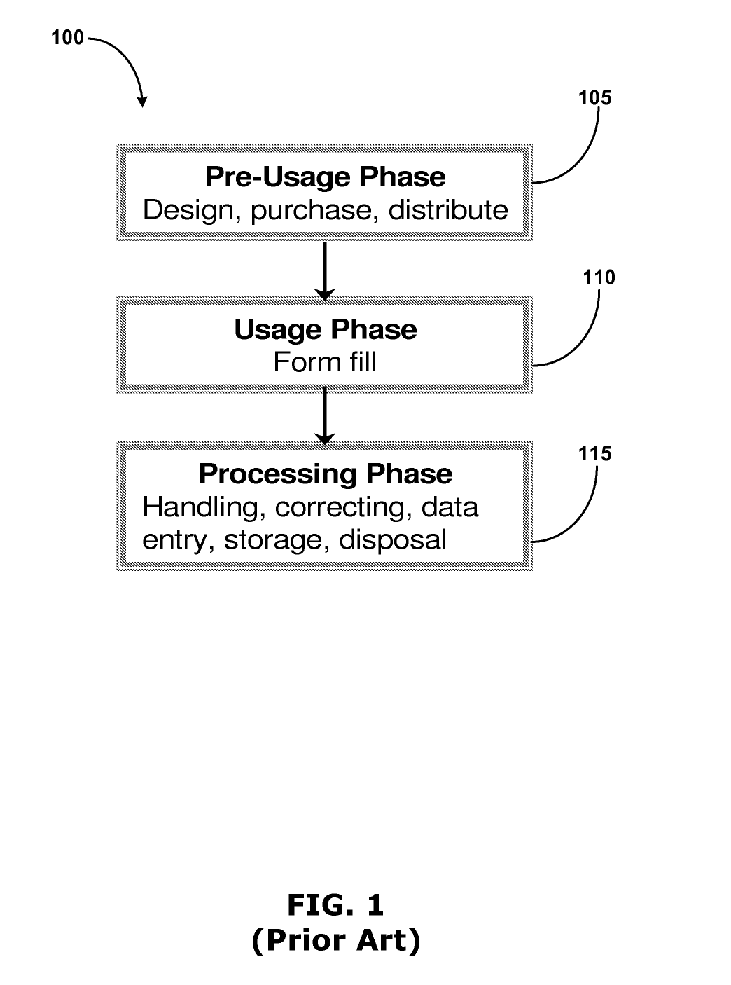

FIG. 1 illustrates a logical flow diagram of a conventional process flow 100 for a chain of custody system utilizing standard paper-based forms. As shown, the process 100 generally comprises a pre-usage phase 105, a usage phase 110, and a processing phase 115. The pre-usage phase 105 generally includes designing a chain of custody system, purchasing necessary items (goods and services) for the system, and distributing the items to numerous users of the system. Also involved in the pre-usage phase 105 is the selection of paper-based chain of custody forms that are pre-printed and sent to system users.

The usage phase 110 generally includes using the items obtained in the pre-usage phase 105. For example, during the usage phase 110, pre-printed chain of custody forms can be completed by hand to record historical data associated with a drug test. Typically, at this stage only information associated with the donor is entered on the form. In the processing phase 115, completed chain of custody forms are distributed to a processing lab to test a donor's test sample, completed upon completion of the test, and then finally sent to a central location for hand processing and entry into a storage system.

The conventional process flow 100 illustrated in FIG. 1 has several drawbacks. Namely, the conventional process 100 is dependent upon using paper as the sole medium for recording data necessary for chain of custody information. While the process 100 generally functions in this manner, it is not efficient and not capable of sharing recorded information with other during the process. For example, because chain of custody related data is recorded on pre-printed paper forms in process 100 the data is not easily shared with others because it resides on the paper form in stagnant form. In addition, due the stagnant nature of data on the form, the data can not be accessed at all by others to obtain real-time status information. Also, paper forms can be easily misplaced or lost adding to time delays associated with conventional chain of custody procedures.

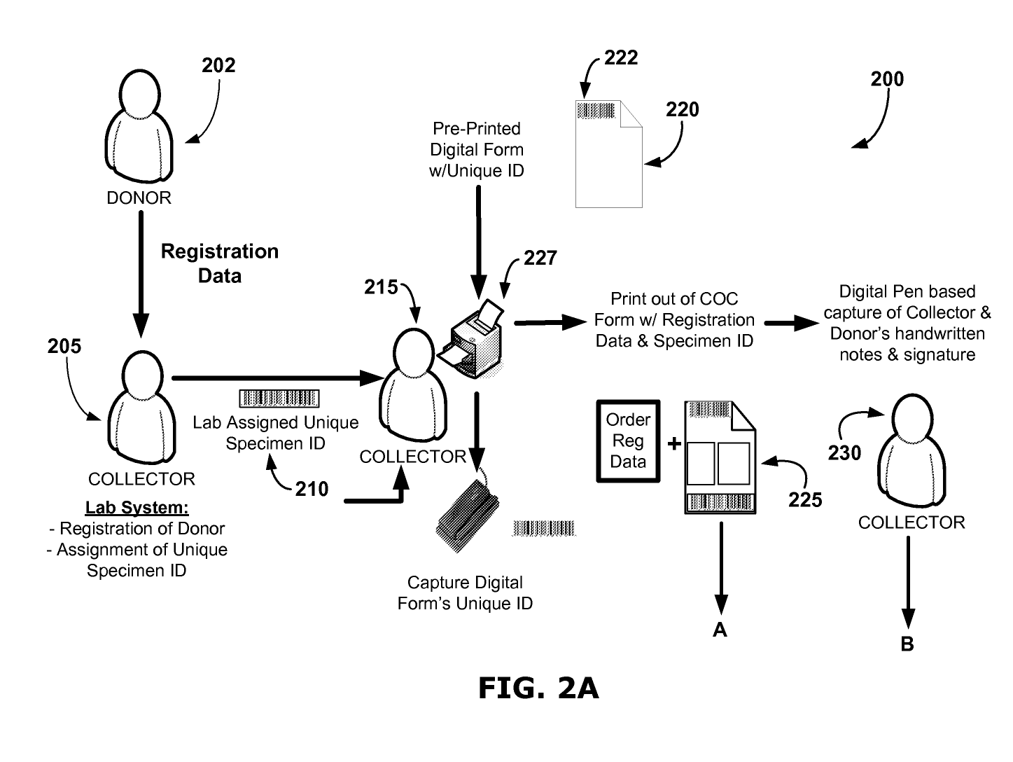

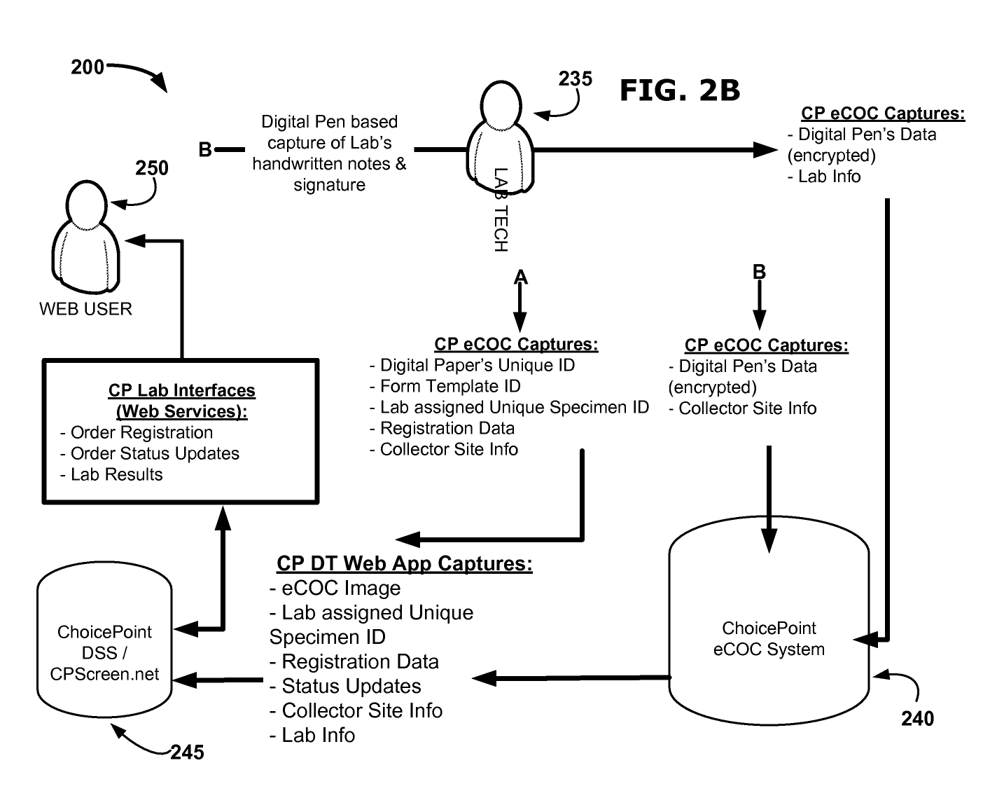

FIGS. 2A & 2B (collectively FIG. 2) illustrate a system and associated information flow for an electronic chain of custody system 200 utilizing a digital chain of custody record in accordance with some embodiments of the present invention. While FIG. 2 illustrates various components in close relation, the various components of FIG. 2 could be placed or positioned in varying locations, such as different geographical places. For example, a storage of data can be located in a single location or comprised of various storage equipment placed in the same or different locations. In addition, various components of embodiments of the present invention are preferably coupled or linked together in a network environment. The network environment can include private networks (e.g., private computer networks), connection over public networks (e.g., the Internet), or combinations of both. In addition, the network environment can include wired connections, wireless connections, or combinations of both.

As discussed herein in more detail, the system 200 enables communication links between paper forms and digital information at various data collection points. This advantageous feature is invisible and hidden to actual system 200 users, even though some users may use conventional pen and paper data recording methods rather than utilize computing equipment to record data. In addition, the system 200 enables integration of data from multiple data collectors to a centralized locale. This advantageous features enables the provision of current, up-to-date status information related to drug tests as well as associated chain of custody information.

As shown in FIG. 2, the system 200 generally includes various interfaces between system participants and computing equipment. The system participants generally include one or more data donors and one or more data collectors. In a drug testing environment, a data donor can include a person undergoing a drug test because they are donating a test sample. In addition, a data donor can include a technician that analyzes a test sample to produce test results related to a test sample. Data collectors can include personnel that collect or receive data for use with the system 200. It should be understood that data donors and data collectors are not mutually exclusive terms as a data donor could also be a data collector and vice versa.

As mentioned above, various components of the system 200 may be located in distinct of geographic locations. Indeed, according to some embodiments drug lab testing facilities, which can be both a data collector and a data donor, may be located at a different location than a specimen collection point. In addition, the system 200 may comprise multiple specimen collection points and drug lab testing facilities. To distinguish these different places from one another, they may be assigned unique IDs. Assignment of such unique IDs enables use of this information for addition to a chain of custody record for a test specimen thereby ensuring that any implemented chain of custody procedures can be followed.

Referring now specifically to FIG. 2A, this figures illustrates a schematic of a data input component of system 200. It should be understood that FIG. 2 directly relates to a drug testing embodiment of the present invention and that other systems requiring chain of custody records are also contemplated. As shown, FIG. 2A illustrates a donor 202, a first data collector 205, a second data collector 215, and a third data collector 230 (the data collectors may include multiple personnel, a single employee, or a computing interface capable of receiving data). The donor 202 and the data collectors 205, 215, 230 interact with each other in a manner that passes chain of custody data into various components of the system 200 thereby forming a digital chain of custody record.

The donor 202 can convey biographical information to the first data collector 205 in a registration process. Such biographical information can include name, address, employer, potential employer, fingerprint information, various biometric information, and the like. According to certain embodiments, the first data collector 205 may be able to access a database (as discussed below in more detail) that already contains desired biographical information about the donor 202. Upon obtaining or accessing the donor's 202 biographical information, the first data collector 205 ensures that the information is accurate and enters data into the system 200 so that the donor 202 is registered. When entered and stored into the system 200, the donor's 202 information becomes accessible by other system 200 users who have the ability to access the system 200.

In addition to obtaining the donor's biographical information to register the donor 200 for a drug test, the first data collector 205 assigns a unique specimen ID to the donor 200. The unique specimen ID 210 can take numerous forms and include alphanumeric characters, barcode information, RFID chips, and the like. What is important is that the unique specimen ID 210 enables system 200 participants to distinguish the donor's 202 test specimen from other test specimens. The unique specimen ID 210 is also preferably entered into the system 200 in such a fashion as to be permanently related to the donor 202. The unique specimen ID 210 can be automatically generated by the system 200 or alternatively keyed into the system 200 by a data collector.

The system 200 can include use of a paper form to initiate a chain of custody record. For example, a second data collector 215 can use a printer 227 and pre-printed form paper 220 to provide a paper form 225 (“COC form 225”). The COC form 225 can have various predefined fields and other information related to the donor 202. For example, the unique specimen ID 220 can be printed onto the COC form 225 such that the COC form 225 is unique to the donor 202. Also, the unique specimen ID 220 can be printed multiple times on the COC form 225 and one printing can be done on a removable portion of the form so that the removable portion can be applied to a container holding a test specimen. According to some embodiments, the removable portion may be a sticker having an adhesive material that can be secured to a test specimen's container.

The COC form 225 may also include a separate unique form ID 222 capable of distinguishing the COC form 225 from other COC forms. The unique form ID 222 can take numerous forms and include alphanumeric characters, barcode information, or a combination thereof. As with the unique specimen ID 220, the important aspect of the unique form ID 222 is to be a distinguishing characteristic of the COC form 225 from other COC forms.

The system 200 can and preferably uses an enhanced type of paper as the pre-printed paper form paper 220. The enhanced paper enables communication between computing equipment and a COC form 225. According to some embodiments, the paper form 225 is preferably marked with a unique pattern that while hidden from the human eye is readable with a digital pen. The pattern may be scanned and read by a digital pen that is moved across the paper to allow determination of the precise location on the paper at which the pen is positioned. At the same time, the digital pen can record its own movements in relation to the pattern to enable recording of the markings that have been placed on that particular location of the paper by the digital pen. Preferably, the printer 227 is adapted and configured to print the unique pattern onto the COC form 225. Alternatively, the paper form 225 can have the unique pattern applied prior to printing by the printer 227.

In designing and testing various embodiments of the present invention, the inventors have utilized a particular brand of marked paper known as Fusion Form. Fusion Form is manufactured by Satori™ located in Scotts Valley, Calif., USA. Fusion Form is provided with a printed pattern known as the Anoto pattern, which is licensed by Anoto Inc., of Waltham, Mass. for production by Certified Printers. While the inventors have used these materials, the various embodiments of the present invention contemplate materials made by other product vendors. As such, embodiments of the present invention can include other types of marked paper having other digital pattern markings.

The current digital pen used by the inventors is also from Anoto. As with the paper and digital markings, other types of digital pens can also be used. The digital pen looks and feels like using its normal ballpoint counterparts. The pen, however, can contain a digital camera, an image microprocessor, and a mobile communications device capable of establishing wireless connections. When using the digital pen, it can capture, store, and securely send the handwriting to another computing device or network. Current Anoto digital pens take digital snapshots of the pattern on the paper (e.g., more than 50 pictures per second). Every snapshot preferably contains data to determine the exact position of the pen and what it writes or draws, including the time each pen stroke was made as well as which particular paper form was written on. This data can be retained in the pen's memory as a series of coordinates. Multiple users can have separate pens with unique ID's such that one user's pen use can be distinguished from another.

The Anoto pattern consists of a unique pattern of dots or shapes printed onto paper that can be read by a digital pen. For example, each page can printed with a unique pattern that uniquely identifies the donor and the sample associated with the digital paper. Also, the unique pattern can be printed on a label that is integrated with the digital paper and is then removed from the paper and secured to a test sample's container. Thus, the label can be separated from a form and placed on a sample container while maintaining the relation to the chain-of-custody. In addition, the label by having the unique specimen ID 220 enables distinction from other test specimens.

Preferably the digital pen is configured to be used with a digital pattern (e.g., the Anoto pattern) and to collect data. For example, as the digital pen writes on the paper, it scans and records the precise location on the paper at which the writing is taking place. The digital pen, at the same time, stores its movements relative to the dot pattern. Also, the pen records pen strokes that are written onto the paper and the precise location on the paper at which the pen stroke was located on the paper.

This information recorded in the pen then can be downloaded to a computer to allow electronic version of the Fusion Form to be created. The Fusion Form can be an electronic PDF copy of the Fusion Form document. The result of the downloading of the digital pen data is that the writing made by the digital pen on the Fusion Form appears on the computer electronic document in the exact location at which it was originally written in ink on the piece of Fusion Form by the digital pen. In other alternative embodiments, the form may be located on computing device such as a PDA, tablet computer, or mobile computer. This arrangement enables system users to interact with an electronic form and provide data directly to an electronic form.

Obtaining donor and drug test specimen data in this fashion also provides additional advantages for electronic chain of custody records. For example, as mentioned above, a COC form 225 can have removable portions that can be secured to a container holding a test specimen. The removable portions preferably contain the unique specimen ID 220 so that a test specimen can be monitored and tracked as it moves through a drug testing protocol. As an example, after authentication of a specimen occurs whereby a donor authenticates the specimen (as discussed below in more detail), the specimen can be transported or moved and tracked by system participants. Such system participants upon taking control over the test specimen can use a data recording device to scan or read the unique specimen ID 220. This scanned or read data can be provided to an associated electronic chain of custody record so that the electronic chain of custody record can be updated. This advantageous tracking feature enables chain of custody record to be monitored and maintained in real time so that an associated electronic chain of custody record can be updated and provided to users who desire such information.

As shown in FIG. 2A, after a donor 202 registers and provides a test sample, the donor 202 can authenticate a provided sample. Authentication can be accomplished with the third data collector 230. The donor 202 and the third data collector 230 can utilize the printed COC form 225 to both authenticate the donor's 202 test sample. For example, both can sign the COC form 225 with a digital pen. The digital pen can transfer the authentication information to the system 200 so that other system 200 participants know that the donor 202 has begun a drug testing protocol. The digital pen can transmit the authentication information wirelessly via a wireless communication protocol or be linked to a computer (e.g., a UBS connection) to transfer the authentication information. In alternative arrangements, authentication may occur by obtaining fingerprint or other biometric information from a donor to determine if such obtained information matches previously recorded data.

In addition, and also shown in FIG. 2A, the third data collector 230 can provide any notes or other such information on a COC form 225. Such information and authentication information can be transferred into the system 200 by use of the specially marked paper and the digital pen thus enabling the information to be transferred to a data storage unit and to update a corresponding digital chain of custody.

FIG. 2A also shows links (A & B) to FIG. 2B. These communication links illustrate how the system 200 shares information between various system collectors, donors, and users. For example, the third data collector's 230 information (B) can be transferred to a lab technician 235. This information can inform the lab technician 235 that a donor's 205 sample is authentic. Also, the third data collector's 230 information can be entered into the system 200. Such dynamic data entry allows system 200 users to access the system and determine that a donor's 202 test sample has been accepted and ready for testing. In addition, a lab technician can provide test result data that can be communicated to the data server 240 (as shown in FIG. 2B).

Referring now specifically to FIG. 2B, this figure illustrates portions of system 200 that relate to a data storage system. The data storage system can include various databases (or data servers) such as data server 240 and web server 245. The data server 240 can be a centralized data storage facility for storing drug testing and associated chain of custody information. Alternatively, the data server 240 can include multiple storage units located in various geographical locations. Preferably, the data server 240 is configured so that system 200 users can access the data stored within the data server 240 to obtain drug test status information and associated COC information.

As for the web server 245, the web server 245 may be coupled to computer networks or devices managed by lab testing networks. Such a configuration enables customers to access the system 200 and obtain information regarding the COC form 225, drug test status information, and associated COC data. That is data server can receive a donor's unique ID, data from a digital pen, information from a form 220, and registration information about a donor 202. Information received by data server 240 can be passed to web server 245, as illustrated, so that system 200 users can access system information over the internet. System information can include information related to registration of a drug test order, status updates about the order and associated donor, and results from testing the donor's sample. As can be appreciated, with the data server 240 retaining information to a specific chain of custody, the data server 240 can retain a digital chain of custody and then obtain additional information to supplement the digital chain of custody. This advantageous feature enables the digital chain of custody to be current and to provide test information to interested parties.

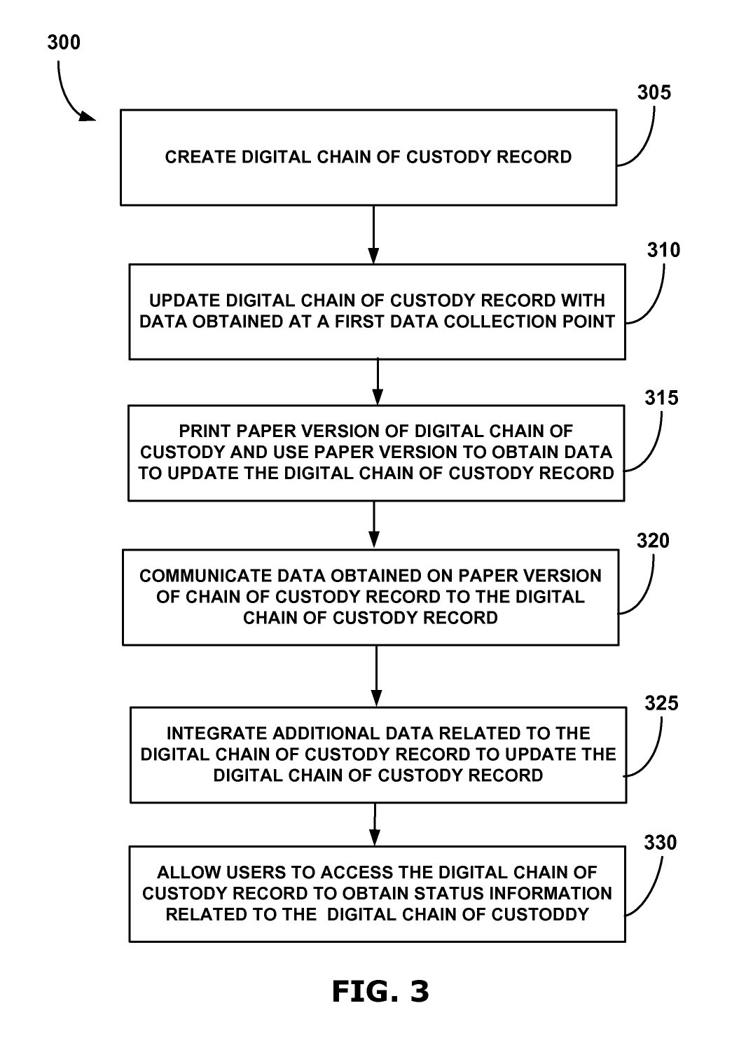

FIG. 3 illustrates a logical flow diagram depicting a method embodiment 300 of an electronic chain of custody system in accordance with some embodiments of the present invention. It should be understood that the method 300 is only one method embodiment of the present invention and that the method 300 can have various additional features or be performed in various orders.

At 305, the method 300 can initiate by creating a digital chain of custody record. A digital chain of custody record can be created upon registering a donor for a drug test, including, for example recording biographical information about the donor. Once registered the donor's chain of custody record can be associated with a unique specimen ID such that the donor's test specimen can be distinguished from other donors. In some embodiments, the chain of custody record can be created by an employer or a drug testing facility. Preferably, the electronic chain of custody record for a donor is stored in a location capable of being accessed and updated by system users. This advantageous configuration provides a centralized storage location for a chain of custody record that can be accessed and updated by system users as described herein.

Enabling employers to create chain of custody records enables additional advantageous features according to some embodiments. As an example, when an employer creates a chain of custody record, an employer may also have the ability to set certain parameters related to an employee's drug test. Sample parameters include the type of drug test being conducted, the type of required test specimen, and time periods related to the drug test. For example, perhaps an employer requests that an employee undergo a drug test within a two-week period and that the employee fails to take a test within the period. If this occurs, a method embodiment can include alerting an employer that an employee did not take a drug test so that the employer can take appropriate action.

After a chain of custody record has been created for a donor, the method 300 can continue at 310 by updating the digital chain of custody record with data obtained at a first data collection point. In some embodiments, if an employer orders a drug test for an employer, the order may be sent to a third-party drug testing facility. Preferably, in such a configuration, the order is transmitted electronically to the drug testing facility. At the drug testing facility, the employee-donor may provide registration data at a data collection point (e.g., registration staff) that may differ from information on the order. In such an instance, once the donor provides updated information, the drug testing facility's registration staff can enter the updated information, which can then be used to update the donor's electronic chain of custody record. Once the chain of custody record is updated, system user can then access this updated information in real time.

The method 300 can also include printing a paper version of the digital chain of custody at 315. Alternatively, an electronic or digital version of the digital chain of custody may be created and used in accordance with the principled discussed herein. The printing can include printing on a Fusion Form (as discussed above) or capturing the digital chain of custody in another format such that additional information can be added to the printed chain of custody. Once printed, the printed chain of custody can be used by a second data collector to obtain donor information and add information to the digital chain of custody. In addition, in some embodiments, the chain of custody is printed on pre-printed chain of custody form paper that is a hard-copy replica of the digital chain of custody record. Also, the printed chain of custody form can have a unique ID to distinguish the form from other printed chain of custody records. A printed version of a chain of custody record can be used by a lab technician to record drug test results or can be used by a donor and a data collector when authenticating a donor's test sample.

Once printed, the second data collector can add information to the printed chain of custody form and then this data can be integrated with the digital chain of custody record at 320. This may occur using a Fusion Form and a digital pen as discussed above whereby the digital pen can transmit information to a network or computing device that in turn can be used to update the digital chain of custody record. For example, the digital pen can be docked to a networked computer such that the information is transferred to the networked computer and then to the computing device retaining the digital chain of custody record. Alternatively, the digital pen can contain a wireless transceiver configured to transmit the information directly to a network to provide the information to the digital chain of custody record. Integration may include replacing stale data by comparing any newly obtained data with stored data.

Communicating this additional information enables integration of data added to the printed chain of custody form to the digital chain of custody record at 325. Advantageously, this ensures that the digital chain of custody record is up to date and does not contain stale, stagnant information such that those accessing the digital chain of custody record obtain up to date information. Indeed, at 330 the method 300 continues by allowing users to obtain updated chain of custody record information stored in the digital COC record file. This advantageous features enables drug testing system participants (e.g., donors, testers, and employers) to obtain current status information of a drug testing procedure.

Method embodiments of the present invention can also include providing information related to a chain of custody record or drug test results. Indeed, status information regarding a drug test or an associated chain of custody can be provided upon user request. According to some embodiments, it may be desired to automatically send status information (e.g., by electronic mail) to users who desire to receive status information at predetermined frequency intervals. As an example, an employer may request to receive drug test status information regarding prospective or current employees to ensure that they have initiated drug testing protocols and that such drug tests are proceeding normally. Further, status information regarding drug test results can also be sent to users by automatic means according to embodiments of the present invention.

While embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by claims and all equivalents filed in a conventional patent application.

We claim:

1. In an electronic chain of custody system comprising at least one digital chain of custody record stored in digital storage and at least one paper chain of custody record corresponding to the at least one digital chain of custody record, a chain of custody system comprising:
an electronic chain of custody record containing donor information, the electronic chain of custody record stored in digital storage;
a paper version of the electronic chain of custody record configured to enable recordation of donor information; and
a data recording device for use with the paper version of the electronic chain of custody record, the data recording device configured to record data added to the paper version and provide the added data to the digital storage such that the electronic chain of custody record is updated with the data added to the paper version.

2. The chain of custody system of claim 1, wherein the data recording device is a digital pen comprising a memory, a processor, and a wireless transceiver, the digital pen being in communication with the digital storage.

3. The chain of custody system of claim 1, wherein the paper version of the electronic chain of custody record comprises a pattern for use with the digital pen, wherein the digital pen records written data with reference to at least a portion of the pattern.

4. The chain of custody system of claim 1, further comprising multiple data collection points to receive additional donor information, the multiple data collection points linked to the digital storage to update electronic chain of custody information corresponding to the additional recorded donor information.

5. The chain of custody system of claim 1, wherein the paper version is a replica of at least a portion of the electronic chain of custody record.

6. The chain of custody system of claim 1, the electronic chain of custody record and the paper version of the electronic chain of custody record sharing a corresponding unique identifier.

7. The chain of custody system of claim 1, wherein the data recording device is a mobile computing unit having an electronic version of the electronic chain of custody record stored on the mobile computing unit.

8. The chain of custody system of claim 1, wherein the paper version of the electronic chain of custody record comprises a removable portion having a unique identifier corresponding to the electronic chain of custody record, the removable portion configured to be securedly affixed to an object.

9. The chain of custody system of claim 1, wherein the electronic chain of custody record has multiple paper versions that correspond to the electronic chain of custody record.

10. The chain of custody system of claim 1, wherein the data recording device has unique identifier such that the data recording device can be distinguished from another data recording device.

11. A method to implement an electronic chain of custody to obtain chain of custody information for a drug test specimen provided by a donor, the method comprising:
providing data storage to store a plurality of unique electronic chain of custody records, the records containing information associated with a test specimen;
providing one or more paper versions of at least one of the electronic chain of custody records, the one or more paper versions containing data from the at least one of the electronic chain of custody records and the one or more paper versions configured to receive chain of custody record data; and
providing a data recording device to receive chain of custody record data provided on the one or more paper versions of the at least one of the electronic chain of custody records.

12. The method of claim 11, further comprising receiving data associated with testing a drug test specimen and providing the received data to the data storage.

13. The method of claim 11, further comprising providing a user stored electronic chain of custody record upon request.

14. The method of claim 11, further comprising storing test result data obtained from testing the test specimen in the data storage and associated with at least one of the unique electronic chain of custody records.

15. The method of claim 11, further comprising providing at least one of a digital pen or mobile computing unit as the data recording device.

16. The method of claim 11, further comprising providing a machine-readable pattern on the one or more paper versions of at least one of the electronic chain of custody records and configuring the data recording device to obtain location information from the machine-readable pattern.

17. The method of claim 11, further comprising printing one or more paper versions of the at least one of the electronic chain of custody records to have a unique identifier that links an electronic chain of custody record to an associated paper version.

18. The method of claim 11, further comprising providing the data recording device with a unique identifier to distinguish the data recording device from another recording device.

19. The method of claim 11, further comprising aggregating drug testing data from a plurality of remote locations to update a chain of custody of record.

20. The method of claim 11, further comprising assigning a unique identifier to a drug testing lab to distinguish the drug testing lab from another drug testing lab and providing the unique identifier to update an electronic chain of custody record.

21. An electronic chain of custody system comprising:
a memory for storing a plurality of unique electronic chain of custody records;
a plurality of data collection points for receiving information related to the unique electronic chain of custody records, the plurality of data collection points linked to the memory; and
at least one data recording device for use with at least one of the plurality of data collection points, the at least one data recording device configured to receive chain of custody data so that at least one of the unique electronic chain of custody records is updated with the received chain of custody data.

22. The system of claim 21, the memory comprising a data server remote from the data collection points and the at least one data recording device to retain the unique chain of custody records.

23. The system of claim 21, the plurality of data collection points comprising computing units configured to receive data from a user, the computing units located remote from the memory.

24. The system of claim 21, the at least one data recording device comprising at least one of a digital pen or mobile computing unit, each of which being configured to temporarily store chain of custody data and provide the chain of custody data to the memory.

25. The system of claim 21, further comprising a paper version of at least one of the unique chain of custody records, the paper version containing data stored in the at least one of the unique chain of custody records and configured to receive data for updating the at least one of the unique chain of custody records.

26. The system of claim 21, further comprising an electronic version of at least one of the unique chain of custody records stored on a mobile computing device, the electronic version containing data stored in the at least one of the unique chain of custody records and configured to receive data for updating the at least one of the unique chain of custody records.

27. The system of claim 21, wherein the at least one data recording device is configured to receive and store data corresponding to a pattern provided on tangible medium.

28. The system of claim 21, further comprising a server module coupled to the memory, the server module configured to provide data associated with at least one of the plurality of unique electronic chain of custody records to a user upon request.

29. The system of claim 21, further comprising a plurality of paper forms having a machine-readable pattern and a unique identifier, the at least one data recording device being configured to record chain of custody information provided on at least one of the paper forms based on movement of the at least one data recording device relative to the machine-readable pattern and provide the chain of custody information and the unique identifier to the memory.

30. The system of claim 21, wherein at least one of the electronic chain of custody records comprises information related to drug testing of a test specimen provided by a donor.

31. An electronic chain of custody record method to maintain and manage chain of custody data associated with a drug test specimen, the method comprising:
creating an electronic chain of custody record having associated unique identification information, the electronic chain of custody record corresponding to a drug test specimen provided by a donor;
providing a version of the electronic chain of custody record at a location remote from the electronic chain of custody record, the version of the electronic chain of custody record having the associated unique identification information;
receiving information associated with at least one of the donor and the drug test specimen via the version of the electronic chain of custody record; and
integrating information received via the version of the electronic chain of custody record with the electronic chain of custody record so that the electronic chain of custody record is updated with the received information.

32. The method of claim 31, further comprising providing at least one of a paper version or an electronic version as the version of the electronic chain of custody record, the version of the electronic chain of custody record comprising at least a portion of information stored in the electronic chain of custody record.

33. The method of claim 31, further comprising providing information associated with at least one of the donor and the drug test specimen to a user upon request thereby allowing the user to obtain status information associated with the drug test specimen.

34. The method of claim 31, further comprising linking the version of the electronic chain of custody record to the drug test specimen with the unique identification information such that the drug test specimen can be distinguished from another drug test specimen.

35. The method of claim 31, further comprising storing the electronic chain of custody record and information associated with the donor and the drug test specimen at multiple geographic locations.
